(19) United States
(12) Patent Application Publication
(10) Pub. No.: US 2009/0310762 A1
(43) Pub. Date: Dec. 17, 2009

(54) System and method for instant voice-activated communications using advanced telephones and data networks

(76) Inventor: George Alfred Velius, St. Louis, MO (US)

Correspondence Address: George Velius, 5605 Chamberlain Ave., St. Louis, MO, 63112, US

(21) Appl. No.: 12/139,465

(22) Filed: Jun. 14, 2008

(51) Int. Cl. H04M 11/00; G10L 15/00

(52) U.S. Cl. 379/93.01; 704/231; 704/270.1; 704/E15.001

(57) ABSTRACT

Instant communications with voice activated connections by both initiating and responding individuals are disclosed using advanced telephones and data networks. A users' speech is captured through an advanced telephone and is automatically recognized to initiate communications with another individual or a group over a data network. The system forwards a predefined communication alert to the designated individual or group. Recipients of the communications alert can indicate acceptance of the communication attempt by speech which is also automatically recognized. Two way communications are instantly established upon acceptance. System configuration, group definitions, user's access permissions, voice activation phrases, and communication alerts are managed through software in a user-accessible network-based service.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

This invention relates to voice and data communications, in particular, to an improved technique for instantly communicating with individuals or groups by utilizing advanced telephones, automatic speech recognition, data networks, and controlling software and services.

Advanced telephones are herein defined to be mobile phones, smart-phones, USB-phones, soft-phones, and other voice communication devices and voice communication systems that are capable of interacting with data networks. A smart-phone is a mobile phone offering advanced capabilities beyond a typical mobile phone, often with functionality similar to a personal computer. A soft-phone is a software program for making telephone calls over the Internet using a general purpose computer, rather than using dedicated hardware. A USB-phone can look like traditional phone device, but it has a USB connector for connecting to computing equipment and data networks rather than an RJ-11 connector for connecting to traditional telephone networks.

2. Description of the Prior Art

People can communicate quickly with each other simply by speaking. Voice communications systems have steadily improved and today allow people a high degree of mobility while retaining the ability to communicate. Still, communication system protocols, user interfaces, and network management often limit the efficiency of communications, especially for tasks involving teams of people.

Communication systems exist that always broadcast to an entire group regardless of who within the group is specifically intended as the recipient. These systems are common in such applications as intercoms and radio dispatch. Efficiency is reduced in these systems since communication initiators typically identify the intended participants audibly, and all participants must listen to determine if the communications is intended for them.

One prior attempt to make remote communications more efficient is the process of voice-dialing, where the initiator of a telephone call may speak a phrase or a series of numbers to directly or indirectly cause a communications network to place a traditional phone call. Voice dialing relies on automatic speech recognition, where the input speech is analyzed by computing equipment to determine which phrase of a predetermined set of phrases was spoken. Voice dialing, however, does not provide the call recipient the capability of engaging in communications in a hands-free manner by using voice commands to respond to the communication attempt.

Another prior attempt at making communications more efficient, referred to as “Transparent Telephony,” is described in U.S. Pat. No. 5,594,784. Transparent Telephony specifies that the caller's initiating utterance be captured and forwarded to the destination with sufficient fidelity to enable the recipient to identify the caller. This method of alerting recipients can take more time than is necessary to establish two-way communications because the recipients have to hear the initiating phrase which may take several times longer than, for example, an alerting signal tone. It also presumes that the recipient is familiar with the caller's voice and that the recipient is in a situation where caller identity is distinguishable, which may not be the case, for example, on a noisy battlefield. Transparent Telephony is also lacking in that it does not provide for establishing instant communications with a group of recipients.

### BRIEF SUMMARY OF THE INVENTION

A system and method is presented for people to communicate instantly with individuals or groups. An initiating user need only speak the user or group designation phrase, and a responding user can speak an acceptance phrase for a two-way connection to be established with the initiating user. The instant communications includes the initiating phrase being automatically recognized. Recognition of the initiating phrase then causes one or more alerts to be sent to the designated recipients. Upon receiving an alert, a recipient may speak an acceptance phrase which is also automatically recognized and may be forwarded to the initiating user. The initiator and recipient are then connected with two-way audio communication and possibly other media such as video, and graphics. Connection times are sufficiently short so that audible coordination of tasks is made extremely efficient. And, unlike intercom systems that broadcast to all team members, team members not part of a designated group are not distracted with irrelevant communications because communication alerts are sent only to those team members who are expressly included in the definition of the designated group.

Voice activation by both the initiator and the recipients allows all participants to communicate in a hands-free manner. Teams that must communicate frequently to be effective, such as military groups, construction crews, sport team members, and others, can improve their team performance with the more efficient and more effective communication capability this invention provides.

The system and method of this invention also allows multiple simultaneous conversations among disjoint sets of users, and instant management of active connections with specified command phrases.

The invention also includes the capability to optionally automatically accept or otherwise handle communication attempts without the need for explicit acceptance of the communication attempt. Where repeated connections are expected from specific users, automatically accepting a connection from a known source can further increase communication efficiency.

The invention also includes the capability to deliver priority alerts. Some communications, such as public emergency alerts, require immediate attention. Priority communications may be instantly delivered to users whether they are actively participating in a conversation or not. For example, the priority communication alert could itself be an alerting audio signal or phrase carrying emergency information. If users are engaged in conversation, the connection handling system could interpose the priority message since it is aware of active connections.

While speech is used as a means of establishing instant two-way communications, those communications need not be limited to audio. The ensuing communications may include images or video or text or other information or data.

The instant communications system and method includes six major parts:
1. Advanced Telephones (AT),
2. software to capture and handle users speech,
3. automatic speech recognition systems to translate spoken phrases into system commands,
4. a data communications network, such as, but not limited to, the Internet, cellular phone networks, and dedicated radio channels,
5. systems and software that implements a connection handling and connection bridging system for the AT information streams on the data communications network,
6. supporting computer systems with software for managing system configuration and control.

The instant communications system may be managed by the user through the use of optional features that control, restrict, modify, or redirect access according to various conditions. Access management may include, but is not limited to: user specified schedules, lists of specified individuals or groups, alternate destinations, automatic responses, and combinations thereof.

### BRIEF DESCRIPTION OF THE DRAWINGS

FIG. 1 illustrates an overview of the instant communication system with person to person communications showing users and major system components.

FIG. 2 illustrates an overview of the instant communication system with person to group communications showing users and major system components.

### DETAILED DESCRIPTION OF THE INVENTION

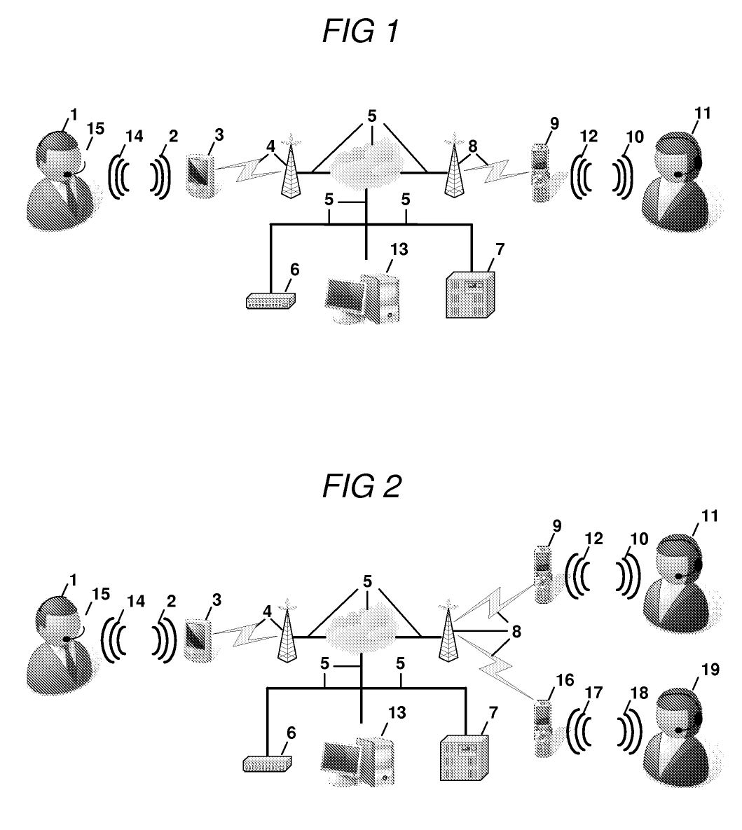

As depicted in FIG. 1, an instant communication system, having been initialized through computer systems 13 with software for managing configuration and control, provides the means for an initiating user 1 to speak a user or group designation phrase. The spoken phrase 2 is captured by software on the initiating users' Advanced Telephone 3 (AT). The AT 3 delivers the captured audio as signal data to the speech processing and recognition system which may include the initiating user's AT 3, network servers 7, or both. To do this, the AT 3 exchanges data with a communications system 4, which in turn exchanges data with a data network 5. The data network 5 interconnects with and communicates data to the connection handler 6 and the network server(s) 7. The speech processing and recognition system determines that the signal data corresponds to a valid user or group designation phrase, and forwards communication initiation information to the connection handler 6. The network server(s) 7 process various forms of input data from user's ATs 3, 9 and transfers results to the connection handler 6. If a spoken phrase was determined to be a valid user designation phrase, the connection handler 6 then initiates a data connection through the data network 5 with the AT 9 belonging to the designated user 11 through a communication system 8. The designated user 11 may be on the same communication network 4 as initiating user 1, or a different communication network 8 connected to the data network 5. Optionally, users may be connected to a data network through wireless networks, wired networks, or combinations thereof. If the designated user 11 is actively accepting communication requests, a predefined communication alert is presented as an audio signal 10 to the designated user 11. The designated user 11 may respond by speaking a phrase 12 indicating acceptance of the communication attempt or a valid communication command phrase. Software on the designated user's AT 9 captures the spoken response phrase 12, and forwards it to the speech processing and recognition system which may include the designated user's AT 9, network servers 7 or both. If the designated user's response indicates acceptance of the communication initiative, the spoken response phrase 12 may optionally be presented as an audio signal 14 to the initiating user 1. Furthermore, if the designated user's response indicates acceptance of the communication initiative, the connection handler 6 initiates a two-way connection to be established between the initiating user 1 and the designated user 11. The two-way connection may be maintained entirely by the users' ATs 3, 9, or by a combination of the ATs 3, 9, the connection handler 6, and possibly also network servers 7 configured to act as a conference bridge of presented media including audio, video, and other media. The AT's 3, 9 continue to capture audio data 2, 12 from both the initiating 1 and the designated user 11, and submit the signal to the speech processing and recognition system. The speech processing and recognition system looks for a valid communication command phrase from either user which may be a disconnect command. When a valid communication command phrase is detected, the communication information is passed to the connection handler 6 for further processing. When the connection handler 6 receives a disconnect command, the two-way audio connections are discontinued. If the designated user 11, is not accepting connection requests, or actively refuses the connection attempt, the connection handler may provide an audio message 14 to inform the initiating user 1.

Connection times are sufficiently short so that audible coordination of tasks is made extremely efficient. And, unlike intercom systems that broadcast to all team members, excluded team members are not distracted with irrelevant communications because a connection includes only those team members expressly identified in the initiating designation phrase.

The users' ATs 3, 9 may be a mobile phone with data services. The AT may be comprised of a mobile phone plus a headset 15 either wired or wireless.

The software on the ATs 3, 9 captures the speech 2,12 from the users 1, 11. When the ATs are powered on some user activation of the software on the AT may be required, or the software may activate automatically. Once active, the software captures the audio data 2, 12 from the user's microphone and presents it to the speech processing and recognition system.

The speech processing and recognition system may be entirely on an AT 3, 9, entirely on a separate computer system 7, or server, connected to the communication or data network 5, or it may be distributed across the AT 3, 9 and the server 7, or other systems connected to the communication or data network 5. The speech processing and recognition system analyzes the audio data for patterns that indicate communication commands such as the initiation of a communication attempt. Since the microphone may always be on or ‘live’, the speech processing and recognition system must be able to distinguish communication commands from other speech uttered by the user as well as ordinary background noise.

The ATs 3, 9 must be capable of exchanging data with a data communication network 5, possibly through a wireless communications system 4, 8. The wireless communication system 4, 8 must be capable of exchanging data with a data communication network 5.

The data communication network 5 must be able to interconnect all the communication systems 4, 8 for all users and groups 3, 9, the computer systems involved in speech processing and recognition 7, the connection handling system 6, and the computer systems 13 for management of the instant communications systems.

The management system 13 implements features such as configuration of system parameters, group definitions, user's access management information, and voice communication command phrases.

Referring now to FIG. 2, group communications are handled in a very similar manner, except for the following. The speech processing and recognition system determines that the signal data from the initiating user 1 corresponds to a valid group designation phrase, and forwards communication initiation information to the connection handler 6. The connection handler 6 attempts to forward one or more alerts 10, 18, which may be the captured group designation phrase, or an alerting signal to the ATs 9, 16 of all members 11, 19 in the designated group. If no designated group member's AT is accessible, a failure notice is returned to the initiating user 1. If a designated group member replies audibly 12, 17, the designated group member's AT captures the spoken phrase and submits the captured speech signal data to the speech processing and recognition system. The speech processing and recognition system determines that the signal data corresponds to a valid communication command phrase, and forwards communication attempt response information to the connection handler 6. If no designated group member replies with a connect acceptance indication, a failure notice is returned to the initiating user 1. If a designated group member 11, 19 replies with a connection acceptance indication, an acceptance alert, which may be the captured acceptance indication phrase from the group member, is returned to the initiating user 1, and the users are connected on a live two-way conference bridge with other group members. The two-way connections may be maintained entirely by the users' ATs 3, 9, 16, or by a combination of the ATs 3, 9, 16, the connection handler 6, and possibly also network servers 7 configured to act as a conference bridge of presented media whether audio, video, or other media. The AT's continue to capture signal data from all participating users 1, 11, 19, and may continue to submit the signal to the speech processing and recognition system. The speech processing and recognition system looks for a valid communication command phrase from each participating user. When a valid communication command phrase is detected, the communication information is passed to the connection handler 6 for further processing. When the connection handler 6 receives a disconnect command from a designated group member, that member's two-way audio connection is discontinued.

For both person to person and person to group communications, the system initialization process involves the communications management system 13 and all participating ATs 3, 9, 16. The communications management system hardware and software must be installed on a network so as to be accessible by users (e.g. the Internet). The communication management system must be configured to support the intended users and groups by entering the voice communication command phrases, and communication alerts for each user designation and each group designation. The communication management system must also be configured to support the intended AT of each user. The ATs must also be initialized by loading and activating AT software on each AT. Furthermore, by using the loaded and activated AT software, connection to the communication management system must be made for further initialization.

What is claimed:

1. A system and method for immediate communications with an individual or a group of people, collectively referred to as users, comprising:
means for capturing audio as digital signal data from said users, and for producing audio from digital signal data, and
means for transmitting and receiving data over a network, and for exchanging information or data between equipment pertaining to said communications, and
means for analyzing said signal data to recognize voice commands from users, and
means for exchanging and simultaneously sharing information with participating users, and
means for managing system configuration and control, user-specific configuration and control, and other information and data related to said communications.

2. A system and method according to claim 1, wherein said means for capturing and producing audio comprises Advanced Telephones (AT) including mobile cellular phones, smart phones, USB phones, soft phones, and other voice communication devices.

3. A system and method according to claim 1, wherein said means for transmitting and receiving data over a network comprises wireless communications systems, cellular telephone systems, public and private wired networks, and combinations thereof.

4. A system and method according to claim 1, wherein said means for analyzing signal data and recognizing voice commands from users comprises one or more automatic speech recognition systems for detecting and determining which phrase or phrases were spoken.

5. A system and method according to claim 1, wherein said means for exchanging and sharing information or data between users and equipment pertaining to said communications comprises means for managing multiple digital signals and for bridging multiple digital signals into one or more composite signals.

6. A system and method according to claim 5, wherein said means for managing multiple digital signals comprises means for bridging multiple digital signals into a customized composite digital signal containing only the information specified by a user who may limit the information received by specifying a list of information attributes.

7. A system and method according to claim 6, wherein said list of information attributes comprises media type, information source, data transfer requirements, and combinations thereof.

8. A system and method according to claim 1, wherein said means for exchanging and sharing information or data between users and equipment pertaining to said communications comprises means for delivering priority information to users as a communication alert, and as an information stream, possibly interrupting previously established communications or information exchanges.

9. A system and method according to claim 1, wherein said means for managing user-specific information comprises an AT, a network-based service, or both.

10. A system and method according to claim 1, wherein said means for managing the system comprises means for users to optionally automatically handle instant connection attempts.

11. A system and method according to claim 10, wherein said means for users to optionally automatically handle instant connection attempts comprises the accepting, rejecting, and forwarding of a communication attempt, based on pre-defined user-selected criteria.

12. A system and method according to claim 11, wherein said user-selected criteria comprises schedule data, information source, media type, information content, and combinations thereof.

13. A system and method according to claims 2 and 4, wherein said AT comprises means for exchanging data with said automatic speech recognition system(s).

14. A system and method according to claim 4, wherein a said spoken phrase is associated with a users address or a group of users' addresses on the said network.

15. A system and method according to claim 14, wherein a pre-defined alert, which may optionally be uniquely associated with the initiating user, is delivered to said address or addresses of the said user or users associated with a said spoken phrase.

16. A system and method according to claim 15, wherein the said pre-defined alert comprises any combination of one or more of: an audio recording, a synthesized audio signal, AT specific alerts including: ringing and other audible indicators, lamps and other visual indicators, and vibration and other tactile indicators.

17. A system and method according to claim 4, wherein some of the said phrases are associated with communication handling procedures giving a responding user voice control over a list of communication features including: accepting a communication initiative, refusing a communication initiative, transferring an initiating user to voice mail, forwarding communications to another network address.

18. A system and method according to claim 17, wherein a said spoken phrase, associated with said communication handling procedure for accepting the communication initiative, is captured by a said responding user's AT and forwarded to the initiating user over the said network to the initiating user's AT where it is processed to produce said audio signal.

19. A system and method according to claim 17, wherein, upon the acceptance of the communication initiative, information in the form of various media including audio, video, graphics, and text is exchanged and shared between the initiating and accepting user or users by said means for transmitting and receiving data over a network.

20. A system and method according to claim 19, wherein said information exchange is concluded by means of said automatic speech recognition systems detecting and recognizing from either the initiating user or a said responding user a said spoken phrase associated with a said communication handling procedure for terminating the said information exchange.

21. A system and method according to claims 7, 12, and 19, wherein said composite digital signal is exchanged with all said users who have indicated acceptance, either explicitly or automatically and is customized per user via pre-defined user-specific communication management system control information.
